(19) United States
(12) Patent Application Publication
(10) Pub. No.: US 2013/0247662 A1
(43) Pub. Date: Sep. 26, 2013

(54) HIGH-PERFORMANCE BENDING ACCELEROMETER

(71) Applicants: Jing Jin, Singapore (SG); Wee Boon Dennis Teo, Singapore (SG); Yuexue Xia, Singapore (SG)

(72) Inventors: Jing Jin, Singapore (SG); Wee Boon Dennis Teo, Singapore (SG); Yuexue Xia, Singapore (SG)

(73) Assignee: MICROFINE MATERIALS TECHNOLOGIES PTE LTD, Singapore (SG)

(21) Appl. No.: 13/992,203

(22) PCT Filed: Dec. 8, 2010
(86) PCT No.: PCT/SG10/00459

§ 371 Date: Jun. 6, 2013

(51) Int. Cl. G01P 15/09

(52) U.S. Cl. CPC G01P 15/0922
USPC 73/504.03; 73/514.34

(57) ABSTRACT

An accelerometer comprises an elastic substrate beam having a first end and a second end and having upper and lower surfaces; supports to support the first and second ends of the substrate beam; sensing elements comprising piezoelectric material bonded onto the upper, lower or both the upper and lower surfaces of the substrate beam; and force applying elements for applying forces at two locations between the first and second ends. The substrate beam and the piezoelectric materials operate in a four-point bending configuration. Optionally the first and second ends of the substrate beam are formed by bending the substrate beam to reduce the physical dimensions of the device.

### FIELD OF THE INVENTION

The invention herein relates to high performance bending accelerometers, particularly accelerometers operating in a four-point bending configuration and comprising piezoelectric materials as sensing elements.

### BACKGROUND OF THE INVENTION

Accelerometers using piezoelectric materials as sensing elements have been widely used. In bending-type accelerometers, piezoelectric patches or layers are bonded onto an elastic beam or plate substrate that deforms in bending, thus producing electrical output.

To achieve high sensitivity in an accelerometer, a cantilever beam is widely employed as the substrate due to the large strain that can be obtained over a small span near the fixed end. However, due to the large strain gradient, the use of larger piezoelectric elements does not offer much advantage in such a design. Furthermore, the large, concentrated strain adjacent to the fixed end may cause cracks in the bonded piezoelectric active materials, which are brittle.

In addition to the above weaknesses, the resonant frequency of a cantilever beam is fairly low. Hence, cantilever bending accelerometers are more suitable for a low working frequency range when a flat response of sensitivity is required.

The sensitivity of piezoelectric-based accelerometers relies fundamentally on piezoelectric properties of the active material used, notably the longitudinal and transverse piezoelectric charge (or strain) coefficients, d₃₃ and d₃₁. Due to their reasonable piezoelectric properties, lead zirconate titanate (PbZr_{0.52}Ti_{0.48}O₃, or “PZT”) ceramics and their derivatives have been extensively used as the sensing elements in many current accelerometers. State-of-the-art PZT ceramics have d₃₃≈400-600 pC/N and d₃₁≈−(150-300) pC/N.

Relaxor-based ferroelectric single crystals such as lead-zinc-niobate-lead-titanate (Pb(Zn_{1/3}Nb_{2/3})O₃—PbTiO₃, or “PZN-PT”) and lead-magnesium-niobate-lead-titanate (Pb(Mg_{1/3}Nb_{2/3})O₃—PbTiO₃, or “PMN-PT”), display piezoelectric properties much superior to state-of-the-art PZT ceramics, with d₃₃≈2000-3000 pC/N and d₃₁≈−(1000-1600) pC/N for [001]-pole single crystals, and d₃₁ values as high as −(3000-4000) pC/N for [011]-poled single crystals.

Despite their superior piezoelectric properties, relaxor-based ferroelectric single crystals have not been used widely as sensing elements in accelerometers. An exception is discussed in P. A. Wlodkowski, K. Deng, and M. Kahn, “The development of high-sensitivity, low-noise accelerometers utilizing single crystal piezoelectric materials”, Sensors and Actuators A, 90, (2000) I25-I31.

Piezoelectric single crystals are highly anisotropic, and currently available PZN-PT and PMN-PT single crystals suffer from high production cost, poor compositional uniformity, and large variations in properties. These deficiencies may have resulted in their limited use at present.

### OBJECTS OF THE INVENTION

It is an object of the invention to provide high-performance accelerometers operating in as four-point bending configuration and having piezoelectric active materials.

It is also an object of the invention to provide an accelerometer comprising an elastic beam substrate fixed at both ends and operating in a four-point bending configuration with piezoelectric active materials bonded onto the beam substrate surfaces as sensing elements.

It is a further object of the invention to provide an accelerometer comprising an elastic beam substrate simply supported at both ends or the equivalent and operating in a four-point bending configuration with piezoelectric active materials bonded onto the beam substrate surfaces as sensing elements.

It is also an object of the invention to provide an accelerometer comprising an elastic beam substrate with end conditions comprising a hybrid of fixed ends and simply supported ends and operating in a four-point bending configuration with piezoelectric active materials bonded onto the beam substrate surfaces as sensing elements.

These and other objects of the invention will become more apparent from the discussion below.

### SUMMARY OF THE INVENTION

The present invention concerns a high-sensitivity accelerometer having an elastic beam substrate and operating in a four-point bending configuration. According to the invention, an elastic beam substrate fixedly supported or simply supported at both ends, or with an in-between end condition, is subjected to two point or line loads preferably, although not necessarily, at equal distances from the central line of the beam substrate, which is referred to a four-point bending. Piezoelectric active materials are bonded onto the beam substrate surfaces as sensing elements. Preferably the sensing elements comprise high performance relaxor-based ferroelectric single crystals. In one embodiment of the invention, an accelerometer has an elastic beam substrate fixed at both ends and operating in a four-point bending configuration with piezoelectric active materials bonded onto the beam substrate surfaces as sensing elements, having force applying elements exerting farces at two locations between the first and second ends.

In another embodiment of the invention, an accelerometer has an elastic beam substrate simply supported at both ends or the equivalent thereof and operating in four-point bending configuration with piezoelectric active materials bonded onto the beam substrate surfaces as sensing elements.

In a further object of the invention, an accelerometer has an elastic beam substrate with supported ends, for example, fixed ends, simply supported ends, or a combination thereof, and using a four-point bending configuration with piezoelectric active materials bonded onto the beam substrate surfaces as sensing elements.

In a yet further embodiment of the invention, the ends of the elastic beam substrate are formed by bending the beam substrate in any suitable configuration to reduce the physical dimensions of the device.

In a yet further embodiment of an accelerometer of the invention, the beam substrate is loaded with two proof masses across the mid span. Preferably, although not necessarily, the two proof masses are positioned at equal distances from either the ends of the elastic beam substrate or the beam substrate supports.

In a yet further embodiment of an accelerometer of the invention, the proof masses are of various designs for easy fabrication and assembly, including splitting the into smaller masses.

In a yet further embodiment of an accelerometer of the invention, the beam substrate may have a width larger than the span and assume a plate-like configuration.

In a yet further embodiment of an accelerometer of the invention, different means and mechanisms are used to produce the described end conditions of the elastic beam substrate.

In a yet further embodiment of an accelerometer of the invention, piezoelectric single crystals with transverse piezoelectric coefficients in excess of 500 pC/N in absolute value and of suitable cuts and dimensions, are used as sensing elements.

In a yet further embodiment of accelerometer of the invention, single crystals with dielectric constants in excess of 1500∈₀ (where ∈₀ is permittivity of vacuum) and of suitable cuts and dimensions, are used as sensing elements.

In a yet further embodiment of an accelerometer of the invention, the sensor elements comprise optimally poled PZN-PT and/or PMN-PT solid-solution single crystals of suitable cuts and dimensions, and/or doped derivatives thereof, which include one or more of the following compositions:

Pb(Zn, A₁, A₂, A₃, . . . )_{1/2}(Nb, C₁, C₂, C₃, . . . )_{2/3}O₃-xPbTiO₃ with 0.045≦x≦0.09 and Pb(Mg, B₁, B₂, B₃, . . . )_{1/3}(Nb, C₁, C₂, C₃, . . . )_{2/3}O₃-yPbTiO₃ with 0.26≦y≦0.33

where
A₁, A₂, A₃, . . . includes at least one of Mg²⁺, Ni²⁺, Fe²⁺, Co²⁺, Yb²⁺, Sc³⁺, and In³⁺ in a total of up to one-third of a mole fraction of Zn²⁺;
B₁, B₂, B₃, . . . includes at least one of Zn²⁺, Ni²⁺, Fe²⁺, Co²⁺, Yb²⁺, Sc³⁺, and In³⁺ in a total of up to one-third of a mole traction of Mg²⁺;
C₁, C₂, C₃, . . . includes at least one of Ta⁵⁺, W⁶⁺ and Mo⁶⁺ in a total of up to one-quarter of a mole fraction of Nb⁵⁺.

In a yet further embodiment of an accelerometer of the invention, the sensor elements comprise suitable cuts and dimensions of optimally poled binary, ternary or higher-order solid solution single crystals of the following components: Pb(Zn_{1/3}Nb_{2/3})O₃, Pb(Mg_{1/3}Nb_{2/3})O₃, Pb(In_{1/2}Nb_{1/2})O₃, Pb(Sc_{1/2}Nb_{1/2})O₃, Pb(Fe_{1/2}Nb_{1/2})O₃, Pb(Mn_{1/2}Nb_{1/2})O₃, PbZrO₃ and PbTiO₃, and their doped derivatives.

In a yet further embodiment of an accelerometer of invention, poled PZT ceramics and their derivatives, including doped derivatives, of suitable configurations and dimensions, are used as sensing elements.

In a yet further embodiment of an accelerometer of the invention, respective sensing elements are connected electrically in parallel, in serial, or in a combination thereof, to suit various application needs.

In a yet further embodiment of an accelerometer of the invention, conventional and/or standard engineering materials are used for the manufacture of an elastic beam substrate, proof masses, end support structures, a mount structure, and/or a housing.

In a yet further embodiment of an accelerometer of the invention, specialty, exotic, and/or noble engineering materials are used for the manufacture of an elastic beam substrate, proof masses, end support structures, a mount structure, and/or a housing for enhanced device performance and/or special purposes.

In a yet further embodiment of an accelerometer of the invention, the performance of the accelerometer, including, but not limited to, its sensitivity, resonant frequency, and/or cross-sensitivity, are enhanced by any known means or technology.

In a yet further embodiment of the invention, a multi-axial accelerometer comprises at least one accelerometer as described herein.

In a yet further embodiment of the invention, a linear motion sensor comprises at least one accelerometer as described herein.

In a yet further embodiment of the invention, a multi-axis motion sensor comprises at least one accelerometer as described herein.

In a yet further embodiment of the invention, an angular rate sensor comprises at least one accelerometer as described herein.

In a yet further embodiment of the invention, a multi-axis angular rate sensor comprises at least one accelerometer as described herein.

In a yet further embodiment of the invention, a rotation motion sensor comprises at least one accelerometer as described herein.

In a yet further embodiment of the invention, a multi-axis rotation motion sensor comprises at least one accelerometer as described herein.

In a yet further embodiment of the invention, a linear-cum-rotation sensor comprises at least one accelerometer as described herein.

In a yet further embodiment of the invention, a multi-axis linear-cum-rotation sensor comprises at least one accelerometer as described herein.

For a full understanding of the present invention, reference should now be made to the following detailed description of the preferred embodiments of the invention as illustrated in the accompanying drawings.

### BRIEF DESCRIPTION OF THE DRAWINGS

FIGS. 1(a) and 1(b) (prior art) are schematic representations of elastic beam substrates loaded in a four-point bending configuration. In FIG. 1(a) an elastic beam substrate is shown with both end fixed, while in FIG. 1(b) an elastic beam substrate is shown where both ends an simply supported.

FIGS. 2(a) and 2(b) are a cross-sectional view and an oblique view, respectively, of an embodiment of a four-point bending accelerometer according to the invention, where the ends of the elastic beam substrate are fixed.

FIGS. 3(a) and 3(b) are a cross-sectional view and an oblique view, respectively, of another embodiment of a four-point bending accelerometer according to the invention, where the ends of the elastic beam are simply supported.

FIG. 4(a) is a cross-sectional view of an another embodiment of a four-point bending accelerometer of the invention in which an end condition in-between fixed and simply supported is realized by using short but flexible end-flanges next to the clamped ends. A detail of FIG. 4(a) is shown in FIG. 4(b).

FIGS. 5(a) and 5(b) are a cross-sectional view and an oblique view, respectively, of an embodiment of the invention in which an elastic beam substrate is bent in an appropriate manner and configuration to provide the flexible end condition and to reduce the physical dimensions of the device.

FIG. 6 is a schematic representation showing the directions of strains on the surfaces of four-point bending on a beam according to the invention, as shown in FIG. 1(a).

FIG. 7 is a schematic cross-sectional representation of another embodiment of a four-point betiding accelerometer according to the invention, where, compared to, for example, the embodiment set forth in FIGS. 2(a) and 2(b), additional piezoelectric sensing elements are bonded onto the be substrate and the wiring is depicted.

FIG. 8 a schematic cross-sectional representation of an embodiment of the invention with multiple piezoelectric sensing elements, similar to the one shown in FIG. 7, but where the electrical wires are connected in serial electrically for enhanced device sensitivity.

FIGS. 9(a) and 9(b) are representations of 2-dimensional and 3-dimensional accelerometers made from the four-point bending accelerometers of the present embodiment, with FIG. 9(a) showing a 2-dimensional sensing arrangement and FIG. 9(b) showing a 3-dimensional sensing arrangement.

FIG. 10 is a representation of an angular rate sensor employing a pair of four-point bending accelerometers according to the invention.

FIG. 11 is a representation of a 2-dimensional angular rate sensor comprising four-point bending accelerometers according to the invention, for sensing rotation about the x-axis and z-axis.

### DETAILED DESCRIPTION OF THE PREFERRED EMBODIMENTS

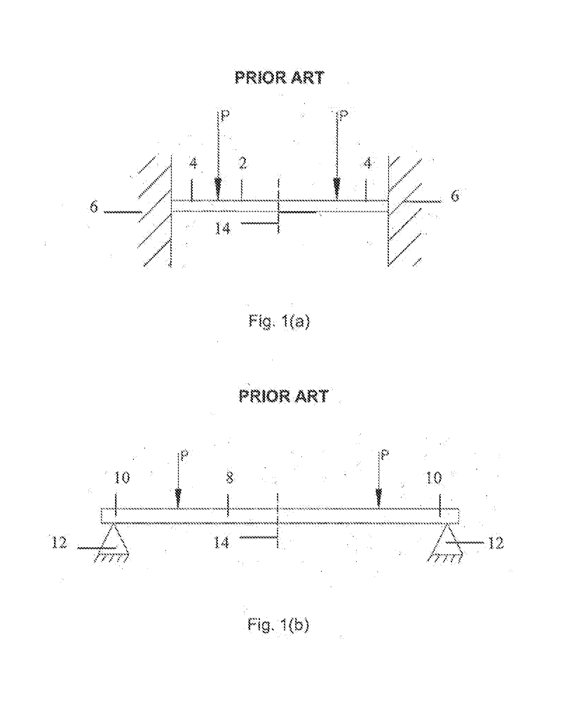

The preferred embodiments of the present invention will now be described with reference to FIGS. 1 to 11 of the drawings. Identical elements in the various figures are designated with the same reference numerals.

FIGS. 1(a) and 1(b) illustrate an elastic substrate beam subjected to four point bending condition according to known art, that is, it is fixed or simply supported at both ends or having an in-between condition is subjected to two point or line loads at equal distances from its central line. In FIG. 1(a) the elastic beam substrate (2) is shown with both ends (4) fixed in fixed supports (6), while in FIG. 1(b) the elastic substrate (8) is shown where both ends (10) are simply supported by supports (12). In each case force or pressure (P) is exerted at points away from the centerline (14).

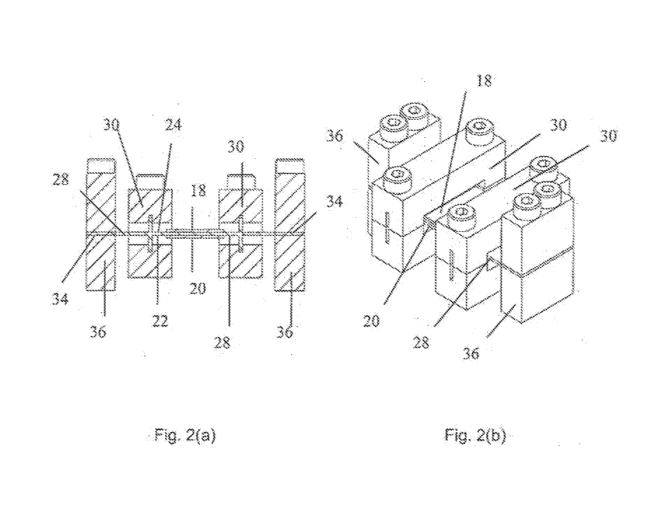

A fixed-end four-point bending accelerometer can be realized by fixing the elastic beam substrate at both its ends by, for example, mechanical fastening, welding, or brazing, and attaching two proof masses over the desired span. This aspect of the invention is illustrated in FIGS. 2(a) and 2(b), where single piece or multiple pieces of piezoelectric active materials (18, 20) are bonded onto the top and bottom surfaces (22, 24) of an elastic beam substrate (28) in mid span between two loads (30). The respective ends (34) of beam substrate (28) are mechanically clamped by supports (36). Piezoelectric materials (18, 20) deform together with elastic beam substrate (28) when elastic beam substrate (28) is set in motion. Piezoelectric materials (18, 20), which function as the sensing elements, are bonded onto top and bottom surfaces (22, 24) by means of epoxy or another suitable bonding agent or means.

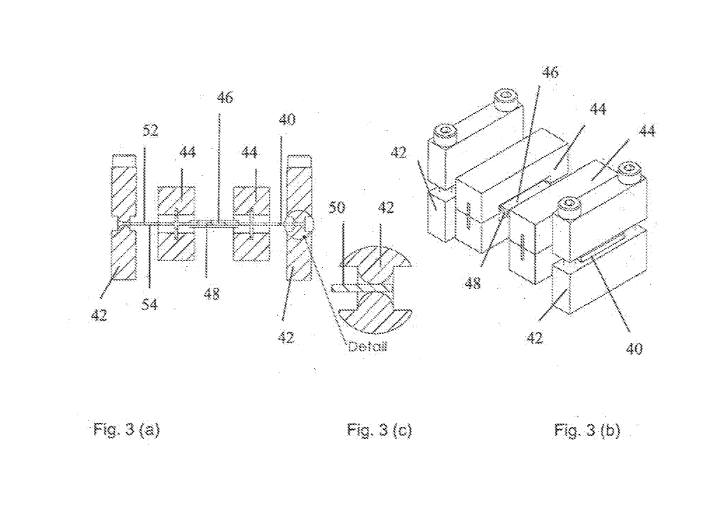

A simply-supported four-point bending accelerometer is set forth in the representations of FIGS. 3(a) to 3(c), with an elastic beam substrate (40), knife-edge supports (42), proof masses (44), and active piezoelectric active materials (46, 48). The ends (50) of elastic beam substrate (40) are each clamped with knife-edge supports (42) such that while supported ends (50) are fixed in position in space, they are free to rotate. Piezoelectric active materials (46, 48), which are bonded by means of epoxy or another suitable bonding agent or means onto the top and bottom surfaces (52, 54) of elastic beam substrate (40), function as the sensing elements.

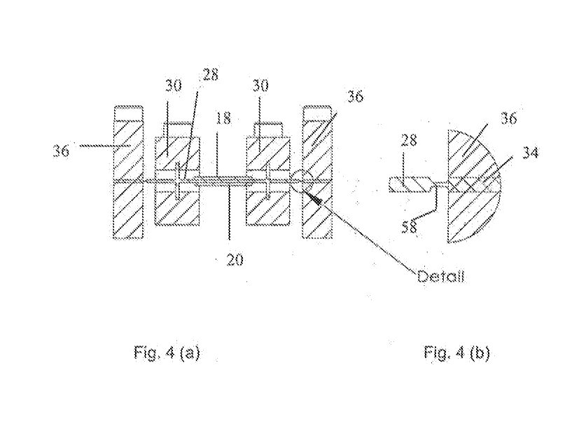

A variation of the embodiment set forth in FIGS. 2(a) and 2(b) is shown in FIGS. 4(a) and 4(b), where an end condition in-between fixed end and simply supported is realized by using short but flexible end-flanges (58) adjacent the clamped ends (34).

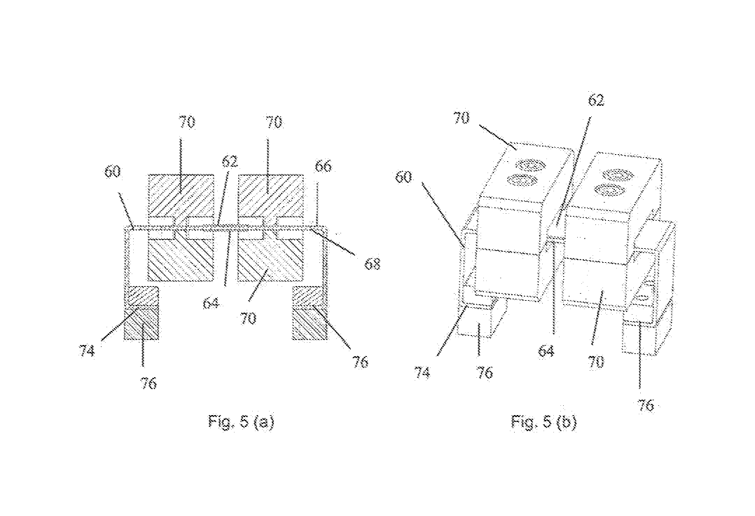

The embodiment of the invention set forth in FIGS. 5(a) and 5(b) is another design example to bend an elastic beam substrate (60) to achieve a flexible end condition. Single piece or multiple pieces of piezoelectric active materials (62, 64) are bonded onto the top and bottom surfaces (66, 68) of elastic beam substrate (60) between two loads (70). The respective ends (74) of beam substrate (60) have been bent downwards at right angles and then back at right angles into supports (76), where they are mechanically clamped. This and similar designs can be used to advantage to reduce the physical dimensions of the resultant device. Piezoelectric materials (62, 64) deform together with elastic beam substrate (60) when elastic beam substrate (60) is set in motion. Piezoelectric materials (62, 64), which function as the sensing elements, are bonded onto top and bottom surfaces (66, 68) by means of epoxy or another suitable bonding agent or means.

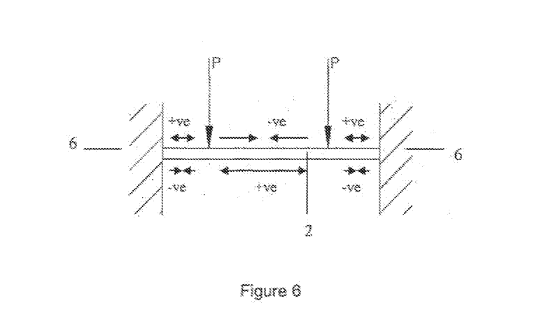

With downward loads as shown in FIG. 1, the beam substrates in both afore-described cases experience bending. The principal surface strains along the length of the beam in the mid span between the two loads and those in the two outer spans are of opposite signs, as shown in FIG. 6, where the arrows represent the direction of strain on the beam substrate surface. Positive (+ve) and negative (−ve) signs indicate tensile and compressive surface strains, respectively, in the length direction of the beam. While the surface strain remains relatively constant in the mid span, they vary along the length of the beam for the outer spans. The surface strains change sign but their magnitudes remain about the same when upward loads are applied instead.

Compared to a cantilever beam, a four-point bending beam displays relatively high and uniform surface strain and hence stress in the mid span between the two loads. This makes possible the use of piezoelectric active materials of much larger area without loss of sensitivity, which is not possible for the cantilever beam design because of the large stress gradient present. This feature, that is, use of piezoelectric active materials of much larger area without loss of sensitivity, can, in turn, be used advantageously for either improved sensitivity or improved electrical capacitance of the resultant device, as will be illustrated below.

While the voltage output of a rectangular transverse-mode piezoelectric sensing element is proportional to the separation of the electrode faces, which is also the thickness of the sensor, its capacitance is inversely proportional to the same but proportional to the area of the electrode faces. For a given device capacitance, the larger area of piezoelectric active materials thus allows the use of thicker active materials which directly translates to higher sensitivity of the device.

Alternatively, for a given sensor thickness, the larger area of the piezoelectric material translates to a higher device capacitance, which would mean a device of reduced electronic noise and hence improved signal-to-noise ratio.

Compared to cantilever beams, four-point bend beams have much higher resonant frequencies. This is especially so for fixed-end font-point bend beams. Thus, for comparable dimensions, four-point bending accelerometers are preferred when a higher working frequency range is desired.

When the fixed or support ends of the accelerometers of the present invention are coupled rigidly to the structure under motion and/or vibration, due to the inertial effect, the proof masses exert a force onto the beam at respective loading locations, causing the beam to deform under four point bending condition. The piezoelectric active materials, which are bonded onto the top or bottom surface, or preferably, both the top and bottom surfaces, of the beam also experience the same bending strain, producing electrical output in the process.

Preferably, the two proof masses are deposited at equal distance from the fixed ends or the simply-supported points of the beam, for a balanced bending of the beam. This helps to reduce the cross sensitivity (i.e., the charge or voltage output in the two unintended orthogonal directions) of the accelerometer. Depositing the loads at unequal distances from the fixed or simply-supported ends are also possible alternative designs although not preferred.

The deposition of the proof masses should be such that the resultant loads are as close to line loadings as possible and that their presence would not affect the free vibration behavior of the beam. Deviations from the above guideline are possible for the afore-described accelerometer to function as intended but the sensitivity of the device may be affected to various degrees.

The proof masses may be of various designs for easy fabrication and assembly including splitting them into smaller masses.

More preferably, the beam should be sufficiently wide and thick to reduce twisting and/or other undesirable deformation modes to help reduce the cross sensitivity of the device, but not too wide to induce complicated stresses gradient at the surface of the beam nor too thick to adversely affect the sensitivity of the device.

The intended sensing axis of the accelerometer of the present invention is in the direction normal to the largest face of the beam. Preferably, its cross-sensitivity, i.e., that in the two unintended orthogonal directions, is ≦6%, more preferably ≦3%, of the on-axis sensitivity.

The end designs in FIGS. 2(a) to 5(b) are for illustration purposes. Other end designs which served the same intended function also fall into the scope and letter of the present embodiment.

The piezoelectric active material used should be sufficiently compliant to follow the deformation of the elastic beam substrate. It must also have reasonable or high transverse piezoelectric charges and/or voltage coefficients, as the sensitivity of the accelerometer, expressed in term of charge or voltage output per given acceleration unit, is proportional to the transverse piezoelectric coefficients of the active material used.

Lead zirconate titanate (PbZr_{0.52}Ti_{0.48}O₃ or PZT) ceramics and derivatives, including doped derivatives, have transverse piezoelectric coefficients in excess of 50 pC/N in absolute value are suitable materials for sensing materials of the accelerometers of the present embodiment.

As shown in Table 1 below, relaxor-based ferroelectric PZN-PT or PMN-PT single crystals have transverse piezoelectric coefficients and large elastic compliances superior to those of PZT ceramics. Suitable slices or segments of PZN-PT and PMN-PT single crystals of high transverse piezoelectric coefficients are therefore preferred materials as sensing elements of the accelerometer of the present embodiment.

Compared to PZT ceramics, PZN-PT or PMN-PT single crystal have much higher dielectric constant (K^{T}). This means that accelerometers made from these single crystals will have considerably higher capacitance, lower electrical noise, and hence higher signal-to-noise (S/N) ratio.

TABLE 1
Transverse piezoelectric properties of differently-poled PZN-PT and PMN-PT
single crystals and of PZT ceramics

| | | d₃₁* | s₁₁^{E}* | Dielectric constant |
|---|---|---|---|---|
| Material | Cut orientation | (pC/N) | (10⁻¹² m²/N) | (K₃₃^{T}) |
| PZN-xPT | [001]-poled, | −(750-1500)^{2,3,4} | 82-90^{2,3,4} | 5000-8000^{2,3,4} |
| (0.05 < x < 0.08 | of [100]-length | | | |
| | [001]-poled, | −1425⁵ | 39⁵ | 7256⁵ |
| | of [110]-length | | | |
| | [011]-poled, | −(2500-4000)^{3,6} | 150-180³ | 4200-6000^{3,6} |
| | of [100]-length | −1460⁷ | 100⁷ | 3180⁷ |
| | [011]-poled, | 1000⁶ | 68⁸ | 5000⁶ |
| | of [0-11]-length | 330-480^{7,8} | | 3180-3800^{7,8} |
| PMN-yPT | [001]-poled, | −(750-1400)^{3,4,9} | 56^{4,9} | 4000-7500^{3,4,9} |
| (0.27 < y < 0.3 | of [100]-length | | | |
| | [001]-poled, | −(799-1025)^{4,9} | 23⁴ | 5330-6550^{4,9} |
| | of [110]-length | | | |
| | [011]-poled, | −(1500-2500)^{9,10,11} | 110-126^{9,10} | 4033¹⁰ |
| | of [100]-length | | 80-100¹¹ | 6000-7000^{9,11} |
| | [011]-poled, | 610¹⁰ | 18-23^{9,10,11} | 4033-5300^{9,10} |
| | of [0-11]-length | 710-820^{9,11} | | 6000-7000¹¹ |

| | | | |
|---|---|---|---|
| PZT ceramics | −80 to −300 | 15-50 | 300-3000 |
| (for comparison) | | | |

*Also designated as d₃₂ and s₂₂^{E} for [011]-poled crystals of [100]-active length.
¹P. A. Wlodkowski, K. Deng, and M. Kahn, “The development of high-sensitivity, low-noise accelerometers utilizing single crystal piezoelectric materials”, Sensors and Actuators A 90, (2000) 125-131,
²R. Zhang, B. Jiang, W. Cao and A. Amin, “Complete sets of material constants of 0.93Pb(Zn_{1/3}Nb_{2/3})O₃—0.07PbTiO₃ domain engineered single crystal”, Journal of Materials Science Letters, 21 (2002), 1877-1879.
³K. K, Rajan, M. Shanthi, W. S. Chang, J. Jin and L. C. Lim, “Dielectric and piezoelectric properties of [001] and [011]-poled relaxor ferroelectric PZN-PT and PMN-PT single crystals”, Sensors and Actuators A, 133 (2007), 110-116,
⁴R. Shukla, K. K. Rajan, M. Shanthi, J. Jin, L. C. Lim and P. Gandhi, “Deduced property matrices or domain-engineered relaxor single crystaqls of [100](L) × [001](T) cut: Effects of domain wall contributions and domain-domain interactions”, Journal of Applied Physics, 107 (2010), article no. 014102.
⁵R. Shukla, P. Gandhi, K. K. Rajan and L. C. Lim, “Property matrices of [001]-poled Pb(Zn_{1/3}Nb_{2/3})O₃-(6-7)% PbTiO₃ single crystals of [110]-length cut: a modified approach”, Japanese Journal of Applied Physics, 48 (2009), article no. 081406.
⁶K. K. Rajan, J. Jin, W. S. Chang and L. C. Lim, “Transverse-mode properties of [011]-poled Pb(Zn_{1/3}Nb_{2/3})O₃—PbTiO₃ single crystals: Effects of composition, length orientation, and poling conditions”, Japanese Journal of Applied Physics, 46 (2007), 681-685.
⁷R. Zhang, B. Jiang and W. Cao, “Superior d₃₂* and k₃₂* coefficients in 0.955Pb(Zn_{1/3b}Nb_{2/3})O₃—0.045PbTiO₃ and 0.92Pb(Zn_{1/3b}Nb_{2/3})O₃—0.08PbTiO₃ single crystals poled along [011]”, Journal of Physics and Chemistry of Solids, 65 (2004), 1083-1086.
⁸R. Zhang, B. Jiang, W. Jiang, and W. Cao, “Complete sets of elastic, dielectric and piezoelectric coefficients of 0.93Pb(Zn_{1/3}Nb_{2/3})O₃—0.07PbTiO₃ single crystal poled along [011]”, Applied Physics Letters, 89 (2006), article no. 242908.
⁹J. Peng, H. Luo, D. Lin, H. Xu, T. He and W. Jin, “Orientation dependence of transverse piezoelectric properties of 0.70Pb(Mg_{1/3}Nb_{2/3})O₃—0.30PbTiO₃ single crystals”, Applied Physics Letters, 85 (2004), 6221-6223.
¹⁰M. F. Wang, L. Luo, D. Zhou, X. Zhao, and H. Luo, “Complete sets of elastic, dielectric and piezoelectic properties of orthorhombic 0.71Pb(Mg_{1/3}Nb_{2/3})O₃—0.29PbTiO₃ single crystal”, Appiled Physics Letters, 90 (2007), article no. 212903.
¹¹M. Shanthi, L. C. Lim, K. K. Rajan and J. Jin, “Complete sets of elastic, dielectric and piezoelectric properties of [011]-poled Pb(Mg_{1/3}Nb_{2/3})O₃—(28-32)% PbTiO₃ single crystals”, Applied Physics Letters, 92 (2008), article no. 142906.

An accelerometer of high capacitance and resistance also has reduced charge or current leakage. This property is important for piezoelectric devices working at low frequencies such as seismic accelerometers, for which charge or current leakage is a major concern when operating without a signal conditioner.

Doped PZN-PT single crystals a suitable cuts may also be used as the sensing elements of the accelerometer of the present embodiment. Said doped PZN-xPT single crystals may be doped with at least one of elements A₁, A₂, A₃, . . . and B₁, B₂, B₃, . . . according to the formula:

Pb(Zn,A₁,A₂,A₃, . . . )_{1/3}(Nb,B₁,B₂,B₃, . . . )_{2/3}O₃-xPbTiO₃

wherein
x is in mole fraction given by 0.05≦x≦0.09;
A₁, A₂, A₃, . . . includes at least one of Mg²⁺, Ni²⁺, Fe²⁺, Co²⁺, Yb²⁺, Sc³⁺, and In³⁺ in a total of up to one-third of a mole fraction of Zn²⁺; and
B₁, B₂, B₃, . . . includes at least one of Ta⁵⁺, W⁶⁺ and Mo⁶⁺ in a total of up to one-quarter of a mole fraction of Nb⁵⁺.

Doped PMN-PT single crystals of suitable cut and dimensions may also be used as the sensing elements of the accelerometer of the present embodiment. Said doped PMN-yPT single crystals may be doped with at least one of elements A₁, A₂, A₃, . . . and B₁, B₂, B₃, . . . according to the formula:

Pb(Mg,A₁,A₂,A₃, . . . )_{1/3}(Nb,B₁,B₂,B₃, . . . )_{2/3}O₃-yPbTiO₃

wherein
y is in mole traction giver by 0.26≦x≦0.33;
A₁, A₂, A₃, . . . includes at least one of Mg²⁺, Ni²⁺, Fe²⁺, Co²⁺, Yb²⁺, Sc³⁺, and In³⁺ in a total of up to one-third of a mole fraction of Mg²⁺; and
B₁, B₂, B₃, . . . includes at least one of Ta⁵⁺, W⁶⁺, and Mo⁶⁺ in a total of up to one-quarter of a mole fraction of Nb⁵⁺.

In addition to doped single crystals, optimally poled binary, ternary, or higher-order solid solution single crystals of suitable cuts and dimensions and of the following components may also be used as sensing elements: Pb(Zn_{1/3}Nb_{2/3})O₃, Pb(Mg_{1/3}Nb_{2/3})O₃, Pb(In_{1/2}Nb_{1/2})O₃, Pb(Sc_{1/2}Nb_{1/2})O₃, Pb(Fe_{1/2}Nb_{1/2})O₃, Pb(Mn_{1/2}Nb_{1/2})O₃, PbZrO₃ and PbTiO₃.

Preferably, suitably dimensioned, that is, having useful shapes, thicknesses, lengths, and widths, slices, segments, or pieces of optimally poled single crystals of PZN-PT or PMN-PT, or their doped derivatives, are used as sensing elements in the four-point bending accelerometer of the present invention, for improved sensitivity, low device noise, and high signal-to-noise ratio, especially when the device is targeted for low-frequency operation such as a seismic accelerometer.

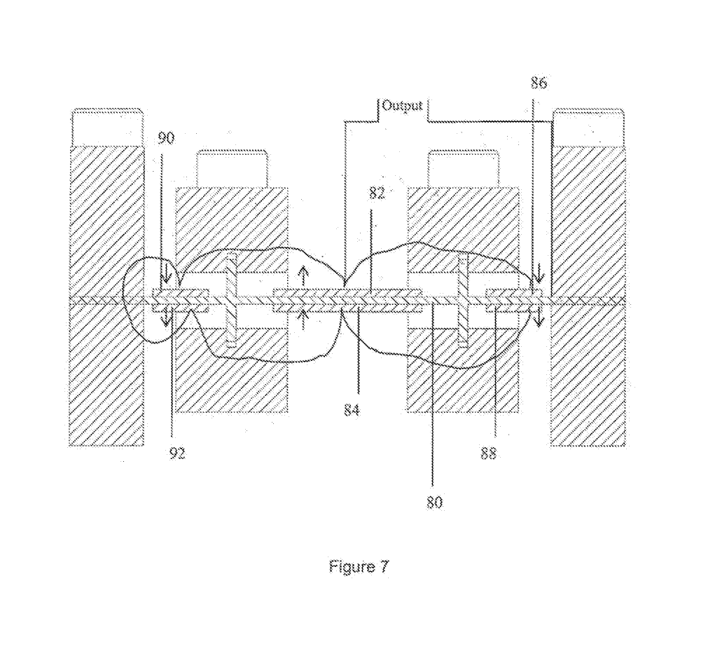

A larger number of piezoelectric active materials can be used by bonding them onto both the mid span and the outer spans of the beam substrate, as shown in FIG. 7. However, due to the change of sign of strains in the surface layer over the entire span of a four-point bend beam, as shown in FIG. 6, extra care should be exercised in bonding and wiring the piezoelectric active materials with respect to the poling directions and the sign of the charge or voltage produced by respective crystals to suit the application needs.

An example of way of bonding and electrical connection of the piezoelectric active materials of the present invention is shown in FIG. 7. The arrows indicate the poling directions of the piezoelectric sensing elements, and the lines represent the electrical wires. In this design, a beam substrate (80) is used as the common ground, and the piezoelectric sensing elements (82, 84, 86, 88, 90, 92) are connected in parallel electrically. This design gives increased capacitance while maintaining about the same voltage output of the device.

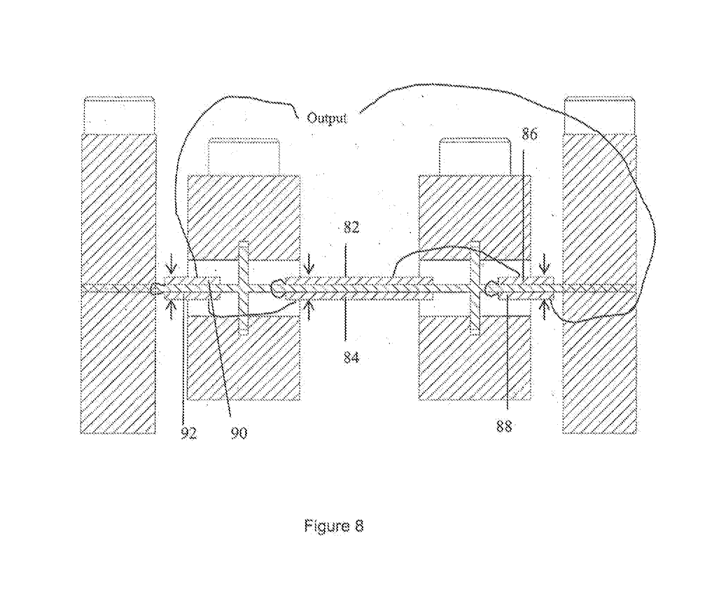

FIG. 8 shows yet another example of bonding and electrical connection of the piezoelectric active materials of the present invention. The arrows indicate the poling directions of the piezoelectric sensing elements, and the lines are the electrical wires. In this deign, the piezoelectric sensing elements are all connected in serial electrically. This design gives increased voltage output but reduced device capacitance.

In yet another embodiment of the invention, the piezoelectric active materials may be connected partially in serial and partially in parallel to attain the desired voltage sensitivity and device capacitance to suit the various application needs.

As compared to fixed-end four-point bending accelerometers, simply supported four-point bending accelerometers are expected to be of higher sensitivity but lower resonant frequency. A four-point bending accelerometer with an end condition in-between fixed and simply supported will have intermediate sensitivities and resonant frequencies. The various types of end conditions can thus be used to advantage to suit the various application needs.

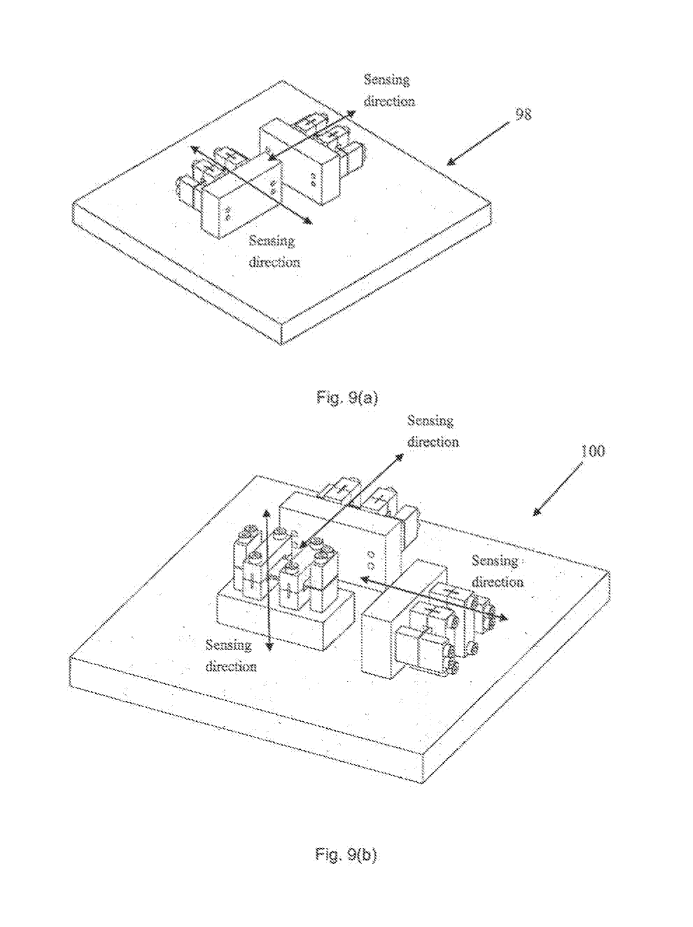

Two or more four-point bending accelerometers of the present embodiment can be mounted onto a common base structure in orthogonal orientations to make 2-dimensional or 3-dimensional accelerometers. Examples of such 2-dimensional (98) and 3-dimensional accelerometers (100) are set forth in FIGS. 9(a) and 9(b). A mixture of the four-point bending accelerometer of the present embodiment and accelerometers of other types or working principles may also be used to make 2-dimensional and 3-dimensional accelerometers when so desired.

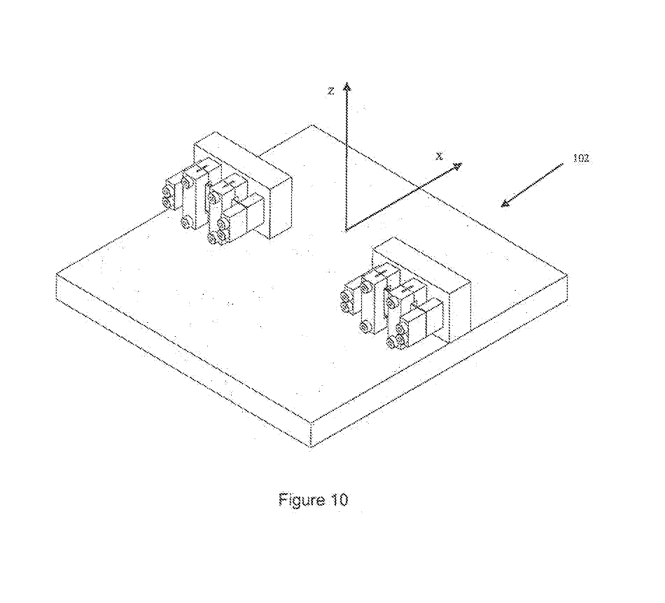

FIG. 10 is a representation of an embodiment of an angular rate sensor (102) employing a pair of four-point bending accelerometers of the invention for rotation sensing purposes. The output differential of four-point bending accelerometers of said device (102) gives the rate of rotation of the device about the z-axis shown, while their sum gives the linear acceleration in the y-direction.

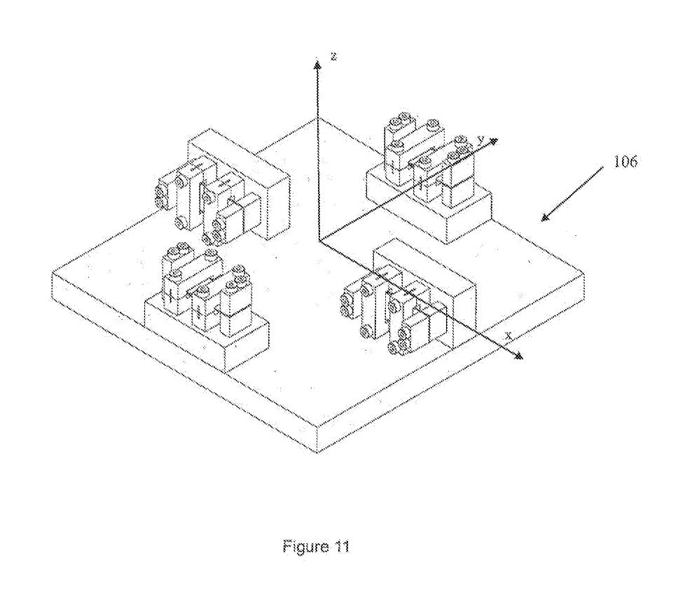

FIG. 11 is a representation of an embodiment of a design in which a number of four-point bending accelerometers of the invention are used to make a two-axis angular rate sensor (106), for sensing rotation about the x-axis and the y-axis. The device (106) also senses linear accelerations in the z- and y-directions as shown in FIG. 11 when the sum (instead of difference) of the outputs of each pair of component four-point bending accelerometers is taken. The device is thus a 4-axis sensor. Also, the same concept can be extended to make a 6-axis sensor for sensing 3-dimensional rotation and 3-dimensional linear acceleration. Similar design concepts can be extended readily to make 3-axis angular rate sensors of suitable configurations when so desired.

The devices shown in FIG. 10 and FIG. 11 also function as a multi-axis linear-cum-rotation sensor when both the sum and difference outputs of respective pairs of accelerometers are utilized to advantages. The present invention thus covers a range of multi-axis linear-cum-rotation motion sensors in which at least one of the component accelerometers is made of a four-point bending accelerometer of the present embodiment.

It would be obvious to a skilled person that the configurations, dimensions, materials of choice of the elastic beams, the proof masses and the piezoelectric sensing materials, and the ways and techniques that desired end conditions of the beam are realised, that the two loads are applied, and that the piezoelectric sensing elements are attached to the beam of the four-point bending accelerometer of the present embodiment may be adapted, modified, refined or replaced with a slightly different but equivalent method without departing from the principal features or working principle of our invention. These substitutes, alternatives, modifications, or refinements are to be considered as falling within the scope and letter of the following claims.

1. An accelerometer comprising:
an elastic substrate beam having a first end and a second end and having upper and lower surfaces;
supports to support the first and second ends of the substrate beam;
sensing elements comprising piezoelectric material bonded onto the upper, lower, or both the upper and lower surfaces of the substrate beam; and
force applying elements for applying forces at two locations between the first and second ends,
whereby the substrate beam and the piezoelectric materials operate in a four-point bending configuration.

2. The accelerometer of claim 1, wherein:
(a) the first and second ends of the substrate beam are fixed by the supports;
(b) the first and second ends of the substrate beam are simply-supported by the supports;
(c) the first and second ends of the substrate beam are supported by the supports in the way between fixed-end and simply-supported condition; or
(d) the substrate beam is bent at both ends to reduce the physical dimensions of the device.

3-5. (canceled)

6. The accelerometer of claim 1:
(a) wherein two proof masses are positioned across the beam substrate in between the two ends to provide a load to the beam substrate;
(b) the accelerometer of (a), wherein the proof masses are each positioned at an equal distance from either support of the substrate beam;
(c) the accelerometer of (a) or (b), wherein each of the respective proof masses comprises two or more smaller masses.

7-8. (canceled)

9. The accelerometer of claim 1, wherein the substrate beam has a plate-like configuration with a beam width equal to or larger than its span.

10. The accelerometer of claim 1, wherein the piezoelectric material comprises piezoelectric single crystals with transverse piezoelectric coefficients in excess of 500 pC/N in absolute value.

11. The accelerometer of claim 1, wherein said sensing elements comprise single crystals with dielectric constants in excess of 1500₀ and wherein ₀ is permittivity of vacuum.

12. The accelerometer of claim 11, wherein the sensing elements comprise at least one of optimally poled PZN-PT or PMN-PT solid-solution single crystals or doped derivatives thereof, said crystals comprising:
Pb(Zn, A₁, A₂, A₃, . . . )_{1/3}(Nb, C₁, C₂, C₃, . . . )_{2/3}O₃-xPbTiO₃ with 0.045≦x≦0.09 and Pb(Mg, B₁, B₂, B₃, . . . )_{1/3}(Nb, C₁, C₂, C₃, . . . )_{2/3}O₃-yPbTiO₃ with 0.26≦y≦0.33
where
A₁, A₂, A₃, . . . includes at least one of Mg²⁺, Ni²⁺, Fe²⁺, Co²⁺, Yb²⁺, Sc³⁺, and In³⁺ and totals up to one-third of a mole fraction of Zn²⁺;
B₁, B₂, B₃, . . . includes at least one of Zn²⁺, Ni²⁺, Fe²⁺, Co²⁺, Yb²⁺, Sc³⁺, and In³⁺ and totals up to one-third of a mole fraction of Mg²⁺;
C₁, C₂, C₃, . . . includes at least one of Ta⁵⁺, W⁶⁺, and Mo⁶⁺ and totals up to one-quarter of a mole fraction of Nb⁵⁺.

13. The accelerometer of claim 11, wherein the sensing elements comprise at least one of optimally poled binary, ternary, or higher-order solid solution single crystals of suitable cuts and dimensions of the following components: Pb(Zn_{1/3}Nb_{2/3})O₃, Pb(Mg_{1/3}Nb_{2/3})O₃, Pb(In_{1/2}Nb_{1/2})O₃, Pb(Sc_{1/2}Nb_{1/2})O₃, Pb(Fe_{1/2}Nb_{1/2})O₃, Pb(Mn_{1/2}Nb_{1/2})O₃, PbZrO₃ and PbTiO₃.

14. The accelerometer of claim 1, wherein the sensing elements comprise at least one of the poled PZT ceramics and doped derivatives thereof.

15. The accelerometer of claim 1, wherein the respective sensing elements are connected electrically in at least one of parallel, serial, or a combination thereof.

16. The accelerometer of claim 1, further comprising at least one mount structure.

17. The accelerometer of claim 1, further comprising a housing.

18. A multi-axial accelerometer comprising at least one accelerometer of claim 1.

19. A linear motion sensor comprising at least one accelerometer of claim 1.

20. A multi-axis motion sensor comprising at least one accelerometer of claim 1.

21. An angular rate sensor comprising at least one accelerometer of claim 1.

22. A multi-axis angular rate sensor comprising at least one accelerometer of claim 1.

23. A rotation motion sensor comprising at least one accelerometer of claim 1.

24. A linear-cum-rotation sensor comprising at least one accelerometer of claim 1.

25. A multi-axis linear-cum-rotation sensor comprising at least one accelerometer of claim 1.
